(19) United States
(12) Patent Application Publication
(10) Pub. No.: US 2024/0128474 A1
(43) Pub. Date: Apr. 18, 2024

(54) METAL CARBIDE CATALYST COMPLEX FOR BIFUNCTIONAL ZINC-AIR BATTERY, CONTAINING BOTH VANADIUM METAL AND DIFFERENT TRANSITION METAL, AND ZINC-AIR BATTERY SYSTEM INCLUDING THE SAME

(71) Applicant: Research & Business Foundation SUNGKYUNKWAN UNIVERSITY, Suwon-si (KR)

(72) Inventors: Hongdae LEE, Suwon-si (KR); Gun JANG, Suwon-si (KR); Ho Seok PARK, Seongnam-si (KR)

(73) Assignee: Research & Business Foundation SUNGKYUNKWAN UNIVERSITY, Suwon-si (KR)

(21) Appl. No.: 18/379,894

(22) Filed: Oct. 13, 2023

(30) Foreign Application Priority Data
Oct. 13, 2022 (KR) 10-2022-0131837

(51) Int. Cl. H01M 4/90; H01M 4/88; H01M 12/08

(52) U.S. Cl. CPC H01M 4/9091; H01M 4/8885; H01M 4/9041; H01M 12/08; H01M 2004/8684

(57) ABSTRACT

There are provided a metal carbide catalyst complex for a bifunctional zinc-air battery, containing vanadium metal and a different transition metal, and a zinc-air battery system including the same. Because a catalytic reaction region may be increased by a substituted iron ion and a substituted vanadium ion in a metal carbide catalyst complex for a zinc-air battery, high activity for oxygen evolution reaction (OER) performance and high activity for oxygen reduction reaction (ORR) performance may be exhibited.

### CROSS REFERENCE TO RELATED APPLICATION

The present application claims priority to Korean Patent Application No. 10-2022-0131837, filed on Oct. 13, 2022, the entire contents of which is incorporated herein for all purposes by this reference.

### BACKGROUND OF THE INVENTION

### Field of the Invention

The present invention relates to a metal carbide catalyst complex for a bifunctional zinc-air battery, containing both vanadium metal and a different transition metal, and a zinc-air battery system including the same.

### Description of the Related Art

As concerns about the energy crisis and environmental pollution continue to increase, research into the development of renewable energy storage and conversion technologies is gaining attention.

Among them, zinc-air batteries are receiving great attention as promising energy storage devices because they have high energy density and are environmentally friendly.

At this time, the discharge of a zinc-air battery is a process in which oxygen in the air dissolves into an electrolyte through an air electrode (positive electrode) and reacts with water to form a hydroxide ion. This reaction can also proceed in the reverse direction, and a process in which oxygen is reduced is a discharge process, and a process in which hydroxide ions are oxidized in the reverse reaction is a charging process.

The reaction in which oxygen is reduced during the discharge process is referred to as oxygen reduction reaction (ORR), and the reaction in which hydroxide ions are oxidized during the charging process is referred to as oxygen evolution reaction (OER).

At this time, in order for the zinc-air battery to be capable of both charging and discharging, the air electrode (positive electrode) must be capable of both ORR and OER reactions.

The theoretical open circuit potential (OCP) of existing zinc-air batteries is 1.667 V in basic electrolyte.

However, the actual potential requires a lower discharge potential due to slow ORR and a higher charge potential due to slow OER.

Therefore, an electrocatalyst is needed to reduce overvoltage and enable fast ORR and OER. ORR catalysts currently used are mainly platinum (Pt) and palladium (Pd)-based catalysts, and OER catalysts currently used are mainly iridium oxide (IrO₂) and ruthenium oxide (RuO₂)-based catalysts. But there are some problems.

First, because these catalysts include precious metals, they are very expensive, have limited reserves, and are sensitive to changes in supply, making commercialization a major challenge.

In addition, these catalysts are not active toward each other.

In other words, because the ORR catalysts such as platinum (Pt) or palladium (Pd) do not have OER activity, and the OER catalysts such as iridium oxide (IrO₂) or ruthenium oxide (RuO₂) do not have ORR activity, there is a limitation in using them in a zinc-air battery positive electrode.

Therefore, in order to improve the performance of zinc-air batteries while replacing expensive precious metals, there is a need to develop a bifunctional oxygen catalyst that enables both ORR and OER at the same time and has high activity.

### Documents of Related Art

(Patent Document 1) KR 2017-0039727

### SUMMARY OF THE INVENTION

A technical object to be achieved by the present invention is to provide a metal-organic framework (MOF)-derived catalyst complex for a bifunctional zinc-air battery, containing both vanadium metal and a different transition metal, and a zinc-air battery system including the same.

The technical object to be achieved by the present invention is not limited to the above-described technical object, and other technical objects that are not mentioned will be clearly understood by those of ordinary skilled in the art from the following description.

In order to achieve the technical object, an embodiment of the present invention provides a metal carbide catalyst complex for a zinc-air battery.

The metal carbide catalyst complex for a zinc-air battery according to an embodiment of the present invention may be a porous carbide compound containing vanadium metal and a different transition metal.

In addition, according to an embodiment of the present invention, the different transition metal may include one selected from the group consisting of Fe, Ni, and Co.

In addition, according to an embodiment of the present invention, the amount of the vanadium metal may be 50 wt % to 83 wt %.

In addition, according to an embodiment of the present invention, the amount of the different transition metal may be 10 wt % to 20 wt %.

In addition, according to an embodiment of the present invention, the particle diameter may be 200 nm to 500 nm.

In order to achieve the technical object, another embodiment of the present invention provides a method of preparing a metal carbide catalyst complex for a zinc-air battery.

The method of preparing the metal carbide catalyst complex for a zinc-air battery according to an embodiment of the present invention may include preparing a vanadium metal-containing metal-organic framework (V-MOF),
forming an MOF catalyst complex precursor by substituting a portion of vanadium metal of the V-MOF with a different transition metal; and
preparing a metal carbide catalyst complex containing both the vanadium metal and the different transition metal by heat-treating the MOF catalyst complex precursor.

In addition, according to an embodiment of the present invention, in the preparing of the V-MOF, an MOF of the V-MOF may include one selected from the group consisting of a MIL-47 system, a vanadium metal node, and an organic ligand.

In addition, according to an embodiment of the present invention, in the forming of the MOF catalyst complex precursor, the different transition metal may consist of Fe, Ni, or Co.

In addition, according to an embodiment of the present invention, in the forming of the metal carbide catalyst complex, the heat treatment may be performed within a temperature range of 800° C. to 1,000° C.

In addition, according to an embodiment of the present invention, the amount of the vanadium metal may be 50 wt % to 83 wt %.

In addition, according to an embodiment of the present invention, the amount of the different transition metal may be 10 wt % to 20 wt %.

In order to achieve the technical object, another embodiment of the present invention provides a zinc-air battery system.

A zinc-air battery system according to an embodiment of the present invention includes a positive electrode part that comprises the metal carbide catalyst complex for a zinc-air battery and reacts with oxygen in the air, a negative electrode part arranged to face the positive electrode part and including zinc metal, and an electrolyte.

In addition, according to an embodiment of the present invention, the electrolyte may be an aqueous acid solution or an aqueous alkaline solution.

A metal carbide catalyst complex for a zinc-air battery according to an embodiment of the present invention may exhibit high activity for oxygen evolution reaction (OER) performance and high activity for oxygen reduction reaction (ORR) performance due to its high specific surface area.

In addition, because a catalytic reaction region may be increased by a substituted iron ion and a substituted vanadium ion in a metal carbide catalyst complex for a zinc-air battery according to an embodiment of the present invention, high activity for OER performance and high activity for ORR performance may be exhibited.

In addition, a zinc-air battery system including a metal carbide catalyst complex for a bifunctional zinc-air battery according to an embodiment of the present invention has excellent electrical conductivity and exhibits excellent charge/discharge performance and stability due to its high specific surface area.

The effects of the present invention are not limited to the above-described effects, and it should be understood that the effects include all effects that can be inferred from the configuration of the invention described in the detailed description of the invention or the claims.

### BRIEF DESCRIPTION OF THE DRAWINGS

FIG. 1 is a TEM image showing the structure of a metal carbide catalyst complex for a zinc-air battery according to an embodiment of the present invention.

FIG. 2 is a schematic diagram showing a method of preparing a metal carbide catalyst complex for a zinc-air battery according to an embodiment of the present invention.

FIG. 3 shows SEM images of Preparation Example 1.

FIG. 4 is an XRD analysis result of Preparation Example 1.

FIG. 5 is a graph showing a charge/discharge polarization curve and power density curve of Preparation Example 2.

FIG. 6 is a constant current charge/discharge cycle stability experiment result of Preparation Example 2.

### DETAILED DESCRIPTION OF THE INVENTION

In the following description, the present invention is described with reference to the accompanying drawings. However, the present invention may be implemented in various forms, and thus, is not limited to embodiments described herein. In addition, irrelevant descriptions are omitted to clearly explain the present invention, and throughout the specification, the same or corresponding elements are indicated by the same reference numerals.

Throughout the specification, when a portion is connected (accessed, contacted, or coupled) with other portions, it includes direct connection as well as indirect connection in which the other member is positioned therebetween. Furthermore, throughout the specification, when a portion “includes” an element, another element may be further included, rather than excluding the existence of the other element, unless otherwise described.

The terms used in the present specification are merely used to describe particular embodiments, and are not intended to limit the present invention. The expression of singularity in the specification includes the expression of plurality unless clearly specified otherwise in context. In the present specification, it is to be understood that the terms such as “including,” “having,” and “comprising” are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Hereinafter, an embodiment of the present invention is described in detail with reference to the accompanying drawings.

A metal carbide catalyst complex for a zinc-air battery according to an embodiment of the present invention is described.

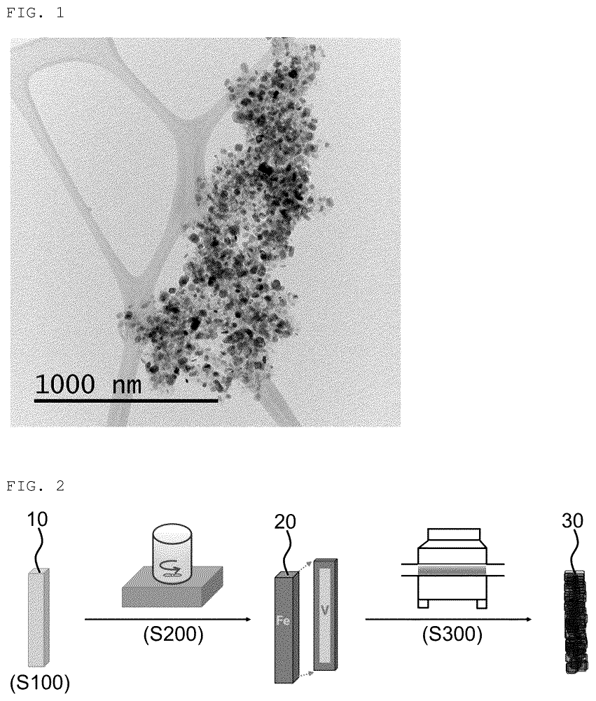

FIG. 1 is a TEM image showing the structure of a metal carbide catalyst complex for a zinc-air battery according to an embodiment of the present invention.

A metal carbide catalyst complex for a zinc-air battery according to an embodiment of the present invention may be a porous carbide compound containing vanadium metal and a different transition metal.

Referring to FIG. 1, it may be identified that vanadium metal and a different transition metal are included within a carbon framework.

In detail, the metal carbide catalyst complex (Fe/V-C) may be a porous carbide compound substituted with a different transition metal.

In this regard, “/” of the Fe/V-C may be to mean that Fe and V exist in parallel and are mixed within a carbon framework.

The metal carbide catalyst complex for a zinc-air battery may be a porous vanadium carbide substituted with a different transition metal, and may be a porous carbide compound formed by substituting a portion of vanadium metal of the vanadium-containing metal-organic framework (V-MOF) with a different transition metal by heat treatment.

First, the metal carbide catalyst complex for a zinc-air battery according to an embodiment of the present invention may have porosity characteristics.

The metal carbide catalyst complex according to an embodiment of the present invention may be based on a metal-organic framework (MOF) which is subjected to heat treatment to prepare a carbide compound, and the pore size of the metal carbide catalyst complex of the present invention may be 27 nm to 104 nm.

The oxygen reduction reaction (ORR) performance and oxygen evolution reaction (OER) performance of a zinc-air battery including the metal carbide catalyst complex may be improved by the porous surface region of the metal carbide catalyst complex.

In Addition, the Present Invention May Include Vanadium Metal.

In this regard, the vanadium metal is located within a carbon structure of a carbide and may chemically bond with carbon, and a carbide compound containing the vanadium metal has porosity and conductivity characteristics and thus may be effective as a carrier.

In addition, in the existing electrocatalyst field, one type of transition metal is included, whereas the present invention further includes vanadium metal, and thus it is possible to prepare an electrocatalyst having bimetallic characteristics.

At this time, in the case of a metal carbide having such bimetallic characteristics, the number of reaction sites is increased compared to existing catalysts containing one type of transition metal, and thus the performance of the catalyst may be further increased.

In this case, in the present invention, the amount of the vanadium metal may be 50 wt % to 83 wt %.

The reason why the amount of the vanadium metal is 50 wt % to 83 wt % is that when the amount of the vanadium metal is less than or equal to 50 wt %, there may be a problem in forming a crystal structure, and when the amount of the vanadium metal is greater than or equal to 83 wt %, there may be a problem in forming vanadium metal.

In Addition, the Present Invention May Include a Different Transition Metal.

The different transition metal may include one selected from the group consisting of Fe, Ni, and Co.

The reason why Fe, Ni, or Co is selected as the different transition metal is that Fe, Ni, or Co metal may be suitable for use as an electrochemical catalyst due to its conductivity characteristics.

In this regard, the different transition metal is located in a mixture with vanadium carbide and may physically bond with excess carbon, and because a carbide compound including the different transition metal has porosity and conductivity characteristics, ORR performance and OER performance may be improved in a zinc-air battery, thereby increasing charge/discharge performance of the zinc-air battery.

In addition, each of the different transition metal and the vanadium metal is located within a carbon framework (carbide) and exists in a dispersed form while being surrounded by a carbon material, and thus, electrical conductivity may be increased, and simultaneously, a catalytic reaction region may be increased.

In this case, the amount of the different transition metal may be 10 wt % to 20 wt %.

In this case, when the amount of the different transition metal is less than or equal to 10 wt %, there may be a problem of deterioration in catalyst performance, and when the amount of the different transition metal is greater than or equal to 20 wt %, there may be problem in forming a carbide.

In this case, the particle diameter of the metal carbide catalyst complex for a zinc-air battery may be 200 nm to 500 nm.

In this case, when the particle diameter of the metal carbide catalyst complex for a zinc-air battery is less than or equal to 200 nm, there may be a problem of non-uniform particle size, and when the particle diameter of the metal carbide catalyst complex for a zinc-air battery is greater than or equal to 500 nm, there may be a problem of deterioration in catalyst performance.

In this case, the particle size of the metal carbide catalyst complex for a zinc-air battery may be adjusted by adjusting the concentration of a reaction solution, reaction time, and heat treatment temperature.

Detailed descriptions of the concentration of the reaction solution, reaction time, and heat treatment temperature for adjusting the particle size are described in connection with a method of preparing a metal carbide catalyst complex for a zinc-air battery.

The different transition metal may exist in a single phase separated from a carbide phase within the carbon framework and may include a single metal or metal oxide.

A Method of Preparing a Metal Carbide Catalyst Complex for a Zinc-Air Battery According to Another Embodiment of the Present Invention is Described.

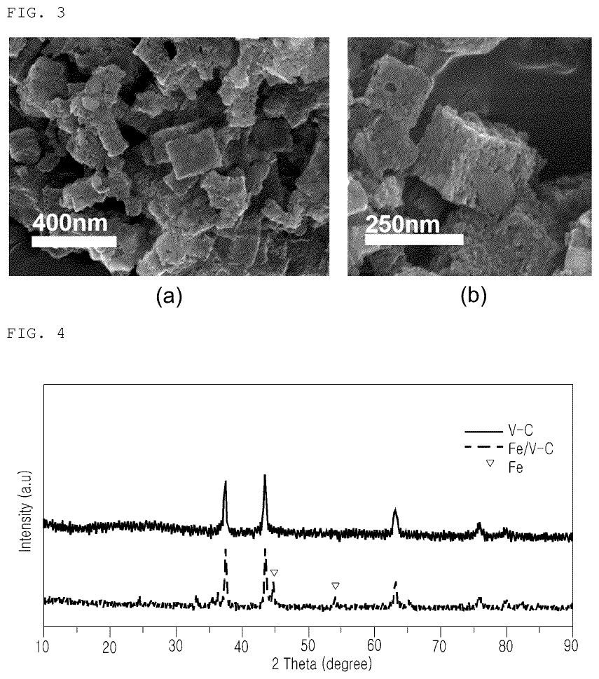

FIG. 2 is a schematic diagram showing a method of preparing a metal carbide catalyst complex for a zinc-air battery according to an embodiment of the present invention.

In FIG. 2, a method of preparing a metal carbide catalyst complex for a zinc-air battery according to an embodiment of the present invention may include:
preparing a vanadium metal-containing metal-organic framework (V-MOF) 10 (S100); forming a MOF catalyst complex precursor 20 by substituting a portion of vanadium metal of the V-MOF with a different transition metal (S200); and preparing a metal carbide catalyst complex 30 containing both the vanadium metal and the different transition metal by heat-treating the MOF catalyst complex precursor (S300).

In the first step, the V-MOF 10 may be prepared (S100).

An MOF of the V-MOF is a type of porous material product and may include an organic linker such as a metal cluster/ion. The MOF includes a metal cluster/ion and an organic linker and is referred to as a secondary building unit (SBU). The structure of the MOF may be modified because its chemical composition may be adjusted.

The MOF has a high surface area and high porosity and thus is widely used in catalysts, gas absorption, sensors, and drug delivery.

In this regard, the MOF used in the present invention may include MIL-47, and any compound having characteristics of MOF compounds may be used and is not limited to the above-described example.

In this case, as an example of a method of preparing the V-MOF, vanadium(III) chloride and 1,4-naphthalenedicarboxylate were heat treated at 200° C. for 48 hours to prepare a V-MOF (MIL-47) compound.

At this time, the vanadium metal may be located within a MOF.

In the second step, a portion of vanadium metal of the V-MOF may be substituted with a different transition metal to form the MOF catalyst complex precursor 20 (S200).

In this case, the different transition metal may consist of Fe, Ni, or Co.

In this case, as an example of a method of substituting a portion of vanadium metal of the V-MOF with a different transition metal, 500 mg of V-MOF (MIL-47) may be mixed in a solvent of 250 g of iron(III) chloride, followed by a hydrothermal reaction at 80° C. for 12 hours to form FeV-MOF which is an MOF catalyst complex precursor.

In this case, the concentration of a mixed solution of iron (III) chloride and V-MOF (MIL-47) may be 15 mg/ml to 20 mg/ml, and when the concentration of the mixed solution is less than or equal to 15 mg/ml, there may be a problem in which vanadium is not substituted because sufficient acidity is not reached, and when the concentration of the mixed solution is greater than or equal to 20 mg/ml, there may be a problem of decomposition of MOF because the acidity is too high.

In the third step, the MOF catalyst complex precursor may be heat treated to prepare the metal carbide catalyst complex 30 containing both the vanadium metal and the different transition metal (S300).

In this case, as an example of a method of manufacturing a Fe/V-C compound as the catalyst complex, FeV-MOF may be subjected to heat treatment at 900° C. for 1 hour.

In this case, the heat treatment may be performed in a temperature range of 800° C. to 1,000° C.

The reason why the heat treatment is performed in a temperature range of 800° C. to 1,000° C. is to suppress metal oxides which may be generated at low temperatures.

When the heat treatment is performed at a temperature of 800° C. or lower, a metal carbide may not be generated, and when the heat treatment is performed at a temperature of 1,000° C. or higher, vanadium may elute.

In addition, the heat treatment may be performed for 1 hours to 10 hours.

When the heat treatment is performed for 1 hours or less, a metal carbide may not be generated, and when the heat treatment is performed for 10 hours or more, there may be a problem with process efficiency because the nanoparticle size does not grow any further.

Therefore, an MOF-derived catalyst complex for a zinc-air battery according to an embodiment of the present invention may exhibit high activity for OER performance and high activity for ORR performance due to its high specific surface area.

In addition, because a catalytic reaction region may be increased by a substituted iron ion and a substituted vanadium ion in a metal carbide catalyst complex for a zinc-air battery according to an embodiment of the present invention, high activity for OER performance and high activity for ORR performance may be exhibited.

In addition, a zinc-air battery system including a metal carbide catalyst complex for a bifunctional zinc-air battery according to an embodiment of the present invention has excellent electrical conductivity and exhibits excellent charge/discharge performance and stability due to its high specific surface area.

In addition, a method of manufacturing a metal carbide catalyst complex for a bifunctional zinc-air battery according to an embodiment of the present invention may be prepared via hydrothermal synthesis, solution synthesis, and heat treatment processes, and the nanoparticle size may be adjusted by adjusting the concentration of a solution, heat treatment reaction time, and heat treatment temperature.

A Zinc-Air Battery System According to Another Embodiment of the Present Invention is Described.

A zinc-air battery system according to an embodiment of the present invention may include: a positive electrode part that includes the metal carbide catalyst complex for a zinc-air battery and reacts with oxygen in the air; a negative electrode part arranged to face the positive electrode part and including zinc metal; and an electrolyte.

The zinc-air battery system is a type of air battery that operates by reacting oxygen in the atmosphere with zinc mixed with an electrolyte via an air electrode of the battery.

In the zinc-air battery system, the positive electrode part may use oxygen in the air, and thus theoretically, the weight of the positive electrode part may be dramatically reduced.

Therefore, as the weight of the positive electrode part is reduced, the weight of the negative electrode part may be increased, and thus, a ratio of the weight of the positive electrode part to the total weight of the zinc-air battery system may be increased, resulting in high energy density per unit weight of the battery.

In this case, the electrolyte is located between the positive electrode part and the negative electrode part and may include an electrolyte material. In this case, the electrolyte may include, for example, a sodium hydroxide (NaOH) solution or a calcium hydroxide (KOH) solution. In addition, the electrolyte may include a solid medium, and in the present invention, the electrolyte may be an aqueous acid solution or an aqueous alkaline solution.

Hereinafter, power generation in the zinc-air battery system is described.

A discharge reaction and a charge reaction may occur in the negative electrode part and the positive electrode part. The discharge reaction in the negative electrode part and the positive electrode part is as follows. The charge reaction is directed in the opposite direction of the following reactions. In the following reaction formula, “M” is a material of an anode 110 and may be a metal.

<Negative Electrode Part Reaction>

M→Mⁿ⁺+ne⁻

<Positive Electrode Part Reaction>

O₂+2H₂O+4e⁻→4OH⁻

Due to such discharge reaction, a positive ion formed in the negative electrode part passes through the electrolyte and is directed to the positive electrode part. In this case, an electron lost from the positive ion passes through a load through a separate conducting wire, ultimately supplying power to the load.

Oxygen is provided to the positive electrode part from the outside, and the positive ion reacts with the oxygen in the positive electrode part to form an oxide. At this time, the electron that has passed through the load is provided to the positive electrode part to form the oxide together.

In contrast, during charging, the oxide is decomposed, and the positive ion obtains an electron and returns to the negative electrode part through the electrolyte from the positive electrode part.

In the present invention, when the positive electrode part includes the metal carbide catalyst complex for a zinc-air battery, the efficiency of ORR, in which oxygen in the air is reduced during a discharge process, and the efficiency of OER, in which hydroxide ions are oxidized during a charging process, may be further increased by an electrocatalytic reaction of the catalyst complex.

In this regard, detailed proof of the efficiency of ORR and the efficiency of OER is described in the following Experimental Examples.

Hereinafter, the present invention is described in more detail via Examples. These Examples are for illustrating the present invention, and the scope of the present invention is not limited by these Examples.

### Preparation Example 1: Preparation of Catalyst Complex (Fe/V-C) for Zinc-Air Battery

First, in order to prepare a V-MOF (MIL-47) compound, 1.579 g of vanadium(III) chloride and 1.081 g of 1,4-naphthalenedicarboxylate were subjected to a hydrothermal synthesis reaction to prepare a V-MOF (MIL-47) compound.

In this case, in order to prepare the V-MOF (MIL-47) compound, heat treatment was performed at 200° C. for 48 hours.

Next, in order to prepare FeV-MOF, 500 mg of V-MOF (MIL-47) and 250 mg of iron(III) chloride were mixed and then subjected to a hydrothermal reaction at 80° C. for 12 hours to synthesize FeV-MOF which is a MOF catalyst complex precursor.

Next, FeV-MOF was subjected to heat treatment at 900° C. for 1 hours to prepare a Fe/V-C compound as a catalyst complex.

Therefore, a catalyst complex (Fe/V-C) for a zinc-air battery was prepared.

### Preparation Example 2: Preparation of Zinc-Air Battery System Including Catalyst Complex for Zinc-Air Battery

First, the catalyst complex (Fe/V-C) for a zinc-air battery prepared according to Preparation Example 1 was used as a positive electrode.

Next, a zinc plate was used as a material for a negative electrode.

Next, a 6 M KOH+0.2 M zinc acetate mixed aqueous solution was used as a material for an electrolyte.

the catalyst complex (Fe/V-C) for a zinc-air battery as the positive electrode, the zinc plate as the negative electrode, and the 6 M KOH+0.2 M zinc acetate mixed aqueous solution as the electrolyte were put together to prepare a zinc-air battery system.

### Experimental Example 1: Experiment to Identify Surface Characteristics of Metal Carbide Catalyst Complex

Referring to FIG. 3, the surface characteristics of the metal carbide catalyst complex are described.

FIG. 3 show SEM images of Preparation Example 1.

FIG. 3 shows an SEM image of the metal carbide catalyst complex of Preparation Example 1 at 45,000 times ((a) of FIG. 3) or 120,000 times ((b) of FIG. 3).

It may be identified that referring to (a) of FIG. 3, the metal carbide catalyst complex has a certain rectangular parallelepiped structure, and referring to (b) of FIG. 3, the metal carbide catalyst complex is a porous material.

### Experimental Example 2: Experiment to Identify Components of Metal Carbide Catalyst Complex

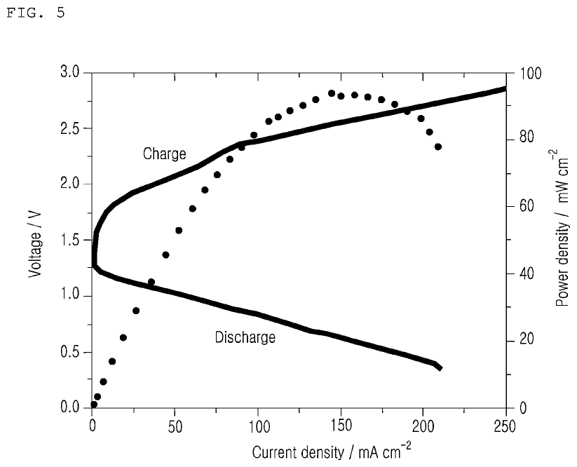

Referring to FIG. 4, component characteristics of the metal carbide catalyst complex are described.

FIG. 4 is an XRD analysis result of Preparation Example 1.

Referring to FIG. 4, because the metal carbide catalyst complex derived from MOF shows peaks at values of 37, 43, and 44, it may be identified that the metal carbide catalyst complex containing iron (Fe) and vanadium (V) is generated.

### Experimental Example 3: Experiment to Evaluate Electrical Performance of Zinc-Air Battery System Including Metal Carbide Catalyst Complex

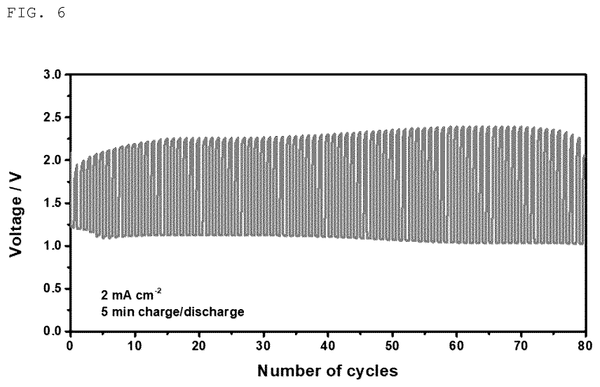

Referring to FIGS. 5 and 6, electrical performance characteristics of the metal carbide catalyst complex are described.

FIG. 5 is a graph showing a charge/discharge polarization curve and power density curve of Preparation Example 2.

FIG. 5 is a graph of charge/discharge voltage and discharge power density according to current density.

Referring to FIG. 5, it may be identified that the zinc-air battery system (Preparation Example 2) prepared by using the metal carbide catalyst complex of Preparation Example 1 as an air electrode (positive electrode) exhibits a power density of 94 mW/cm² and exhibits a value of 1.77 V during charging and a value of 1.18 V during discharging at a current density of 10 mA cm⁻², indicating a low charge voltage and a high discharge voltage.

FIG. 6 is a constant current charge/discharge cycle stability experiment result of Preparation Example 2.

Referring to FIG. 6, it may be identified that the zinc-air battery system (Preparation Example 2) of the present invention provides a charging potential of 2.30 V and a discharging potential of 1.10 V with a voltage difference of 1.20 V.

In addition, it may be identified that the zinc-air battery system (Preparation Example 2) of the present invention has excellent charge/discharge performance and excellent stability by maintaining a charge/discharge voltage difference well while operating for 80 cycles or more.

The above description of the present invention is for illustration, and those of ordinary skill in the art to which the present invention pertains can understand that it can be easily modified into other specific forms without changing the technical spirit or essential features of the present invention. Therefore, it should be understood that the embodiments described above are illustrative in all respects and not restrictive. For example, each element described as a single type may be implemented in a distributed form, and likewise elements described as distributed may be implemented in a combined form.

The scope of the present invention is indicated by the following claims, and all changes or modifications derived from the meaning and scope of the claims and their equivalents should be construed as being included in the scope of the present invention.

### DESCRIPTION OF REFERENCE NUMERALS

10: vanadium metal-containing metal-organic framework (V-MOF)
20: MOF catalyst complex precursor
30: metal carbide catalyst complex

What is claimed is:

1. A metal carbide catalyst complex fora zinc-air battery, wherein the metal carbide catalyst complex is a porous carbide compound containing vanadium metal and a different transition metal.

2. The metal carbide catalyst complex for a zinc-air battery of claim 1, wherein the different transition metal comprises one selected from the group consisting of Fe, Ni, and Co.

3. The metal carbide catalyst complex for a zinc-air battery of claim 1, wherein an amount of the vanadium metal is 50 wt % to 83 wt %.

4. The metal carbide catalyst complex for a zinc-air battery of claim 1, wherein an amount of the different transition metal is 10 wt % to 20 wt %.

5. A method of preparing a metal carbide catalyst complex for a zinc-air battery, the method comprising:
preparing a vanadium metal-containing metal-organic framework (V-MOF);
forming a MOF catalyst complex precursor by substituting a portion of vanadium metal of the V-MOF with a different transition metal; and
preparing a metal carbide catalyst complex containing both the vanadium metal and the different transition metal by heat-treating the MOF catalyst complex precursor.

6. The method of claim 5, wherein, in the preparing of the V-MOF, an MOF of the V-MOF comprises one selected from a metal-organic complex group consisting of a MIL-47 system, vanadium metal, and an organic ligand.

7. The method of claim 5, wherein, in the forming of the MOF catalyst complex precursor, the different transition metal consists of Fe, Ni, or Co.

8. The method of claim 5, wherein, in the forming of the metal carbide catalyst complex, the heat treatment is performed within a temperature range of 800° C. to 1,000° C.

9. The method of claim 5, wherein an amount of the vanadium metal is 50 wt % to 83 wt %.

10. The method of claim 5, wherein an amount of the different transition metal is 10 wt % to 20 wt %.

11. A zinc-air battery system comprising:
a positive electrode part that comprises the metal carbide catalyst complex for a zinc-air battery of claim 1 and reacts with oxygen in air;
a negative electrode part arranged to face the positive electrode part and comprising zinc metal; and
an electrolyte.

12. The zinc-air battery system of claim 11, wherein the electrolyte is an aqueous acid solution or an aqueous alkaline solution.
